(19) United States
(12) Patent Application Publication
(10) Pub. No.: US 2024/0308859 A1
(43) Pub. Date: Sep. 19, 2024

(54) LAYERED MATERIAL DELAMINATING IN POLAR SOLVENTS

(71) Applicant: BYK-Chemie GmbH, Wesel (DE)

(72) Inventors: Hussein Kalo, Landshut (DE); Hubert Schiessling, Landshut (DE); Udo Krappe, Wesel (DE); Berthold Jacobs, Reken (DE); Maximilian Böhmer, Muenster (DE); Tyler Nash, Dripping Springs, TX (US)

(21) Appl. No.: 18/271,487

(22) PCT Filed: Jan. 13, 2022
(86) PCT No.: PCT/EP2022/050648

§ 371 Date: Jul. 10, 2023

(30) Foreign Application Priority Data
Jan. 15, 2021 (EP) 21151931.9

(51) Int. Cl. C01B 33/22; C09C 1/30; C09C 3/04; C09D 7/61

(52) U.S. Cl. CPC C01B 33/22; C09C 1/3018; C09C 3/041; C09D 7/61; C01P 2002/72; C01P 2004/61

(57) ABSTRACT

The invention relates to material comprising a layered material having the composition Naₓ[Mg_{3-z}Li_{y}]Si₄O₁₀(T)₂, wherein x is in the range of 0.4 to 0.8, y is in the range of 0.0 to 0.8, 5z is in the range of 0.2 to 0.8, T independent of each occurrence represents F or OH, and x+(3−z)+y≤4, wherein the powder X-ray diffraction pattern of the layered material has a 001 peak in the range of 8.00 to 5.88° 2Theta, and wherein the 001 peak has a full width at half of the peak maximum 10 of larger than 0.10°, and wherein the layered material has a Z-average particle size of 500 nm or higher, determined by dynamic laser light scattering on an aqueous dispersion of the material containing at most 1.5% by weight of the material.

The invention relates to a layered material, to a process for preparing the material, to a composition comprising the material and a binder, and to the use of the material for improving the barrier properties of a coating layer.

Stöter et al., Langmuir 2013, 29, pp. 1280-1285, describe nanoplatelets of sodium hectorite showing aspect ratios of 20000 upon delamination. The materials are capable to spontaneously and completely disintegrate into single clay lamellae of 1 nm thickness. This synthetic clay offers potential as functional filler in highly transparent nanocomposites with superior gas barrier and mechanical properties. The material was obtained by melt synthesis followed by long-term annealing. Long-term annealing was made in a molybdenum crucible at a temperature of 1045° C. for a period of 6 weeks. The long annealing time at high temperature represents a serious drawback, which makes commercial implementation of the technology less attractive.

US 2011/0204286 A1 relates to synthetic phyllosilicates for polymer/phyllosilicate nano composites. The synthetic phyllosilicates described in this document are present in the form of stacks of layers, also referred to as tactoids. The polymer nano composites comprising these tactoids show improved gas barrier properties. However, there is no full delamination into single clay lamellae. It is generally believed that full delamination maximizes the path length for diffusion through a composite material, thereby improving barrier properties. Therefore, the full potential with respect to gas barrier properties is not reached with the tactoids described in this document.

WO 2019/154758 A describes a method for making a layered material having the composition Na_{0.5}Mg_{2.5}Li_{0.5}Si₄O₁₀F₂ by providing a mixture of fluorides and oxides of Na, Mg, Li, and Si. The mixture is heated to a temperature of 1750° C. to from a homogenous liquid. Subsequently, the mixture is cooled to 1300° C. at a rate of 55° C./min. and further to 1050° C. at a rate of 10° C./min. Finally, it was quenched by switching off the power.

There is an ongoing need for synthetic layered materials that easily delaminate into single clay lamellae, which provide good barrier properties, and which can be prepared by economically viable processes.

The invention provides a material comprising a layered material having the composition Naₓ[Mg_{3-z}Li_{y}]Si₄O₁₀(T)₂, wherein
x is in the range of 0.4 to 0.8,
y is in the range of 0.0 to 0.8,
z is in the range of 0.2 to 0.8,
T independent of each occurrence represents F or OH, and

x+(3−z)+y≤4,

wherein the powder X-ray diffraction pattern of the layered material has a 001 peak in the range of 8.00 to 5.88° 2Theta, and wherein the 001 peak has a full width at half of the peak maximum of larger than 0.1°, and
wherein the layered material has a Z-average particle size of 500 nm or higher, determined by dynamic laser light scattering on an aqueous dispersion of the material containing at most 1.5% by weight of the material.

The material of the invention provides a layered material that easily, and in many cases spontaneously, delaminates into single lamellae. The material can be prepared by economically viable processes.

The layered material is a clay material and can generally be categorized as a hectorite.

Hectorites are magnesium based smectite clays. The layered material of the invention is generally a synthetic clay. The preparation method is discussed further below.

The layered material has the composition Naₓ[Mg_{3-z}Li_{y}]Si₄O₁₀(T)₂, wherein
x is in the range of 0.4 to 0.8,
y is in the range of 0.0 to 0.8,
z is in the range of 0.2 to 0.8,
T independent of each occurrence represents F or OH, and

x+(3−z)+y≤4.

It is preferred that in at least 50%, more preferably at least 70%, and most preferred at least 90% of the occurrences T represents F. In some embodiments, T represents F in 100% of the occurrences.

The ratio of Na, Mg, and Li can vary within the ranges indicated above. In preferred embodiments, the material contains lithium. In these embodiments, y is generally in the range of 0.4 to 0.8. In further preferred embodiments, x is in the range of 0.4 to 0.6, y is in the range of 0.4 to 0.6, and z is in the range of 0.4 to 0.6.

The powder X-ray diffraction pattern of the layered material has a 001 peak in the range of 8.00° to 5.88° 2Theta, and the 001 peak has a full width at half of the peak maximum of larger than 0.10°. It has been found that these features lead to a very easy delamination of the layered material into single lamellae.

The powder X-ray diffraction pattern is generally taken on a powder sample of the layered material, which has been equilibrated with atmospheric moisture at a relative humidity of 43% at 23° C. for a period of at least 12 hours. For measurement of the X-ray diffraction pattern use is made of Copper K-alpha radiation having a wavelength of 1.541 Å.

The position of the 001 peak is defined as the position of peak maximum.

The full width at half of the peak maximum is defined as the width of the 001 peak, expressed in °. The width of the peak is measured at the height which corresponds to half of the value of the maximum intensity.

In preferred embodiments, the full width at half of the peak maximum is at least 0.15°, more preferably at least 0.20°. Generally, the full width at half of the peak maximum is at most 0.60°, preferably at most 0.50°. In typical embodiments, the full width at half of the peak maximum is in the range of 0.15° to 0.60°, preferably 0.20° to 0.50°.

The layered material has a Z-average particle size of 500 nm or higher, determined by dynamic laser light scattering on an aqueous dispersion of the material containing at most 1.5% by weight of the layered material. Generally, the aqueous dispersion contains 0.2 to 1.5% by weight of the layered material.

Dynamic light scattering results are often expressed in terms of the Z-average. The Z-average arises when dynamic light scattering data is analyzed by the use of the technique of cumulants.

Since the calculation of the Z-average is mathematically stable, the Z-average is insensitive to noise. The Z-average can be expressed as the intensity based harmonic mean and is shown by the equation below:

$${D}_{z} = \frac{\sum {S}_{i}}{\sum ( {S}_{i} / {D}_{i} )}$$

Here, Sᵢ is the scattered intensity from particle i and Dᵢ is the diameter of particle i. The result is in the form of a harmonic mean. Since this mean is calculated from the intensity weighted distribution, leading to the statement that the Z-average size is the intensity weighted harmonic mean size.

Generally, the Z-average particle size is in the range of 500 nm to 25000 nm. In preferred embodiments, the Z-average particle size is at least 1000 nm, more preferably at least 1500 nm, and most preferably at least 1800 nm. In typical embodiments, the Z-average particle size is in the range of 1500 to 25000 nm.

Generally, the material of the invention, when present as a material of solid particles, comprises 80 to 100% by weight of the layered material, preferably 90 to 100% by weight, and most preferably 95 to 100% by weight of the layered material. The material may comprise minor amounts of other layered silicates which do not meet the specifications of the layered materials described above.

The invention further relates to a process for preparing the material of the invention. The process comprises the steps of
i) Providing a mixture comprising Na compounds, Mg compounds, Li compounds, and Si compounds, wherein the compounds are selected from carbonates, halides, and oxides, and wherein the molar ratio of Na:Mg:Li:Si is in the range of 0.4 to 0.8:2.2 to 2.8:0.0 to 0.8:4.0,
ii) Heating the mixture to a temperature above 1100° C. to form a homogeneous liquid,
iii) Cooling the mixture to a temperature below 1000° C. during a period of at least 0.5 h.

In the first step, a mixture of Na compounds, Mg compounds, Li compounds, and Si compounds is provided. The compounds are provided in the form of oxides, halides, or carbonates. In typical embodiments, alkali metal salts/alkaline earth metal salts, alkaline earth oxides and silicon oxides, preferably binary alkali fluorides/alkaline earth fluorides, alkaline earth oxides and silicon oxides, preferably LiF, NaF, MgF₂, MgO, quartz are used. In a further prepared embodiment, the material of the invention is prepared from mixture of sodium carbonate, lithium carbonate, magnesium oxide, magnesium fluoride, and silicon dioxide (quartz). The molar ratio of the starting compounds reflects the molar composition of the layered material prepared. Therefore, the molar ratio of the metal compounds used as starting materials is selected to arrive at the molar composition of the layered material as described above.

The relative proportions of the starting compounds may be, for example, from 0.4 to 0.6 mol of F⁻ in the form of the alkali/alkaline earth fluorides per mol of silicon dioxide and from 0.4 to 0.6 mol of alkaline earth oxide per mol of silicon dioxide, preferably from 0.45 to 0.55 mol of F⁻ in the form of the alkali/alkaline earth fluorides per mol of silicon dioxide and from 0.45 to 0.55 mol of alkaline earth oxide per mol of silicon dioxide, particularly preferably 0.5 mol of F⁻ in the form of the alkali/alkaline earth fluorides per mol of silicon dioxide and 0.5 mol of alkaline earth oxide per mol of silicon dioxide.

Preferably, the starting compounds are of high purity. In a preferred embodiment, the individual starting compounds have a content of calcium oxide below 0.05% by weight. It is further preferred, that the individual starting compounds have a content of iron oxide below 0.05% by weight.

In the second step, the mixture of starting compounds is heated to a temperature above 1100° C. to form a homogeneous liquid. Heating is preferably carried out in an open or closed crucible.

Typically, a high-melting crucible made of a metal that is chemically inert or slow to react, preferably of molybdenum or platinum, is used.

Heating is typically carried out in a high-frequency induction furnace. If needed, the crucible is protected from oxidation by a protecting atmosphere (e.g. argon), reduced pressure or a combination of both measures. For precious metals like Platinum this is not necessary.

In the second step, the mixture is heated to a temperature above 1100° C. The temperature must be above the melting temperature of the reaction mixture in order to obtain a homogenous liquid. Generally, the temperature range in the second step is from 1100° C. to 1700° C., preferably from 1300 to 1600° C. Generally, the duration of this step is from 60 minutes to 240 minutes, preferably from 75 minutes to 180 minutes.

In the third step, the mixture is cooled to a temperature below 1000° C. during a period of at least 2.0 h, preferably during a period of at least 3.0 hours.

The third step is generally a controlled cooling step, wherein the temperature of the mixture is decreased to a specified target temperature over a specified period of time. The temperature of the mixture reaches the specified temperature at the end of the specified period of time. In some embodiments, the temperature is decreased evenly during the specified period of time.

Alternatively, the temperature may also be decreased stepwise in 3 or more intervals. Generally, the duration of the third step is in the range of 2.0 to 36.0 hours, preferably in the range of 2.5 to 24 hours. In very preferred embodiments, the duration of the controlled cooling step is in the range of 2.5 hours to 18 hours, even more preferably 4 to 15 hours.

During the controlled cooling step, the mixture is cooled to a temperature below 1000° C. Generally, the mixture is cooled from a temperature of 1100° C. or higher to a temperature below 1000° C. In preferred embodiments, the mixture is cooled to a temperature of 800° C. or lower, even more preferably to a temperature of 600° C. or lower, and most preferably to a temperature of 400° C. or lower.

In further preferred embodiments, the mixture is cooled from a temperature of 1100° C. or higher to a temperature of 600° C. or lower during a period of 4 to 15 hours. In further embodiments, the mixture is cooled from a temperature in the range of 1600 to 1400° C. to a temperature in the range of 600 to 400° C. or lower during a period of 4 to 12 hours.

After the controlled cooling step, the material is generally allowed to cool to ambient temperature.

In some embodiments, the process comprises a further step comprising dispersing the material obtained after step iii) in an aqueous medium comprising water.

Generally, water is the main component of the aqueous medium. Thus, the aqueous medium comprises 65 to 100, preferably 80 to 100% by weight of water. In addition to water, the aqueous medium may comprise other additives and organic polar solvents, preferably solvents which are miscible with water, such as alcohols having 1 to 4 carbon atoms.

Generally, the amount of material dispersed in the aqueous medium is in the range of 0.5 to 20.0% by weight, preferably 1.0 to 18.0% by weight, more preferred 1.5 to 15.0% by weight, in each case calculated on the total weight of the dispersion.

Under these conditions, the material of the invention will in many cases spontaneously delaminate into single lamellae.

In some embodiments, the delamination of the layered material into single lamellae can be facilitated by heating the aqueous medium comprising the dispersed material to a temperature in the range of 50 to 400° C. Very good results have been obtained with heating the aqueous medium to a temperature in the range of 50 to 120° C.

In a further embodiment, the dispersion can be heated in a pressure reactor to a temperature in the range of 180 to 500° C., preferably in the range of 250 to 400° C.

The dispersion is generally heated for a period of 0.5 to 48 hours.

With or without thermal treatment, the aqueous dispersion can be used for formulations providing improved barrier properties. If so desired, the dispersion of lamellae can be separated from any non-delaminated impurities by liquid-solid separation processes, for example by centrifugation. If so desired, the delaminated material can be dried by evaporation of water.

In an alternative embodiment, step iii) of the process is followed by the further steps of grinding the material to a powder and heating the powder to a temperature in the range of 500° C. to 1100° C. for a period of at least 48 hours. To avoid undesired loss of material by evaporation during this heating step, the material may be placed in a closed container.

As mentioned above, the material of the invention is very suitable for improving the barrier properties of composite materials. Therefore, the invention also relates to a composition comprising at least one binder and the material of the invention.

The binder is generally a material capable of forming a layer on a substrate.

Examples of binders include organic polymers and resins, prepolymers, and monomers capable of forming a polymer. The binder may be of natural or synthetic origin, or it may be a synthetically modified natural material. Examples of binders are polyurethanes, polycarbonates, polyamides, polyacrylates, polyesters, polyolefins, rubber, polysiloxanes, polyvinylalcol, polylactides, polysaccharides, poly-lysine, polystyrene, polyalkylene oxides, and polyepoxides, and combinations thereof.

It is preferred that the binder comprises at least one of an aqueous polymer solution or an aqueous polymer dispersion. Examples of binders in an aqueous medium include proteins, polysaccharides, poly-lysine, polyacrylates, polyvinylesters, polyvinylalcohol, polyethylene oxide, oxidized polyolefins, and maleinized polyolefins, and combinations thereof.

In some embodiments, the composition is a liquid composition, which can be applied as a coating to a substrate. When the liquid composition comprises water or an organic solvent as diluent, the composition dries after application to a substrate by evaporation of water or solvent to form a coating layer.

The substrate to be coated can be any suitable substrate to receive a coating layer. Examples of suitable substrate materials are polymers, such as polyesters, polyacrylates, polyvinylchloride, and polyolefins, as well as paper, cardboard, and metals. In some embodiments, the substrate is a polymer foil, for example a polymer foil suitable for food packaging. In other embodiments, the substrate may be in the form of a tray, container or bottle suitable for packaging of food or beverages. In still further embodiments, the substrate may be a metal substrate to be protected against corrosion, such as an iron, steel, or copper or aluminum substrate. The substrate may also be present in the form of a laminate, comprising two or more layers of different materials. Furthermore, the coating layer may itself form an inner our outer layer in a multi-layer material.

The weight ratio of binder to the material of the invention in the composition is generally in the range of 3:97 to 97:3, preferably 7:93 to 93:7.

Incorporation of the material of the invention into a binder can be carried out by means of conventional techniques such as, for example, mixing, stirring, extrusion, kneading processes, rotor-stator processes (Dispermat, Ultra-Turrax, etc.), grinding processes or jet dispersion and is dependent on the viscosity of the binder.

In a further embodiment, the invention relates to the use of the material according to the invention for improving the barrier properties of a coating layer. When included in a coating layer, the material of the invention significantly improves the barrier properties of the coating layer. Relevant barrier properties include the permeation of gases and liquids through the coating layer. Improved barrier properties mean that the permeation of gases and liquids through the coating layer is reduced. Examples of gases for which the permeation is reduced include oxygen, carbon dioxide, water vapor, and nitrogen. Reducing the permeation of these gases is of particular importance in the field of packaging for food and beverage.

### EXAMPLES

### Example 1

### Step a)

A layered material of the formula Na0.5 [Mg2.5 Li0.5] Si4O10 F2 was prepared from a mixture of sodium carbonate (68.8 g, purity 99.9%), Lithium carbonate (47.8 g, purity 99.9%), Magnesium oxide (159.8 g, purity 98.0%), Magnesium fluoride (161.4 g, purity 99.9%), and silicon dioxide (623.0 g, purity 99.9%). The raw material mixture was heated in a platinum crucible to 1530° C. to form a homogeneous melt and kept at this temperature for 2 hours. After this time the melt was poured into a ceramic crucible. The ceramic crucible with the melt was placed in an oven and cooled to a temperature of 400° C. during a period of 6 hours.

### Step b)

After cooling to room temperature, 3.0 g of the layered material prepared in step a) was dispersed in 97.0 g of distilled water by stirring. The aqueous dispersion was heated to a temperature of 80° C. for a period of 45 minutes. Subsequently, about 0.3 g of non-delaminated material was removed from the dispersion by centrifugation (5000 rpm for 10 minutes). The dispersion was dried by evaporation of water and the residue was grinded to a powder.

### Example 2

After cooling to room temperature, 3.0 g of the layered material prepared in step a) of Example 1 was dispersed in 97.0 g of distilled water by stirring. The aqueous dispersion was heated to a temperature of 80° C. The heated dispersion was treated with an IKA ULTRA-TURRAX® T 25 with dispersion tool of S25N 18G at speed of 5000 rpm for a period of 10 minutes. Subsequently, about 0.3 g of non-delaminated material was removed from the dispersion by centrifugation (5000 rpm for 10 minutes). The dispersion was dried by evaporation of water and the residue was grinded to a powder.

### Example 3

After cooling to room temperature, 3.0 g of the layered material prepared in step a) of Example 1 was dispersed in 97.0 g of distilled water by stirring. The aqueous dispersion was heated to a temperature of 80° C. The heated dispersion was treated with an IKA ULTRA-TURRAX@ T 25 with dispersion tool of S25N 18G at speed of 25000 rpm for a period of 10 minutes. Subsequently, about 0.3 g of non-delaminated material was removed from the dispersion by centrifugation (5000 rpm for 10 minutes). The dispersion was dried by evaporation of water and the residue was grinded to a powder.

### Example 4

After cooling to room temperature, 10.0 g of the layered material prepared in step a) of Example 1 was dispersed in 90.0 g of distilled water by stirring. The aqueous dispersion was then placed into a pressure vessel and was heated to a temperature of 300° C. for a period of 48 hours. After cooling to room temperature, the dispersion was dried by evaporation of water and the residue was grinded to a powder.

### Example 5 (Comparative)

After cooling to room temperature, 3.0 g of the layered material prepared in step a) of Example 1 was exposed to a relative humidity of 43% at 23° C. for a period of 12 h and grinded to a powder. The powder was filled into a Si3N4 crucible of a suitable size to be placed in a reactor made from steel type 1.4841. The reactor was closed with a lid made from the same material as the reactor. To render the reactor gas tight at high temperature, the lid was covered with a potassium silicate powder melting at 900° C. The reactor was then placed in a furnace. The furnace was heated from room temperature to 500° C. within 3 h, and held for 12 h. Next the furnace was heated to 1023° C. within one hour. The temperature of the furnace was held for 6 weeks. After 6 weeks the furnace was cooled to room temperature and the powder was recovered from the reactor.

### Example 6 (Comparative)

Example 1 was repeated. However, after keeping the homogenous melt at 1530° C. for two hours, the material was cooled to 25° C. during a period of 15 minutes.

### Determination of X-Ray Diffraction Pattern

The powder of the layered materials of the examples was exposed to a relative humidity of 43% at 23° C. for a period of 12 h before determination of the X-ray diffraction pattern. The X-ray diffraction pattern was determined on an X-ray device of Panalytical empyrean with Pixcel detector. The samples were measured using the following measurement condition and device settings;

| | |
|---|---|
| Start Position [°2Th.] | 2 |
| End Position [°2Th.]: | 20 |
| Step Size [°2Th.]: | 0.0130 |
| Scan Step Time [s]: | 14.810 |
| Scan Type: | Continuous |
| PSD Mode: | Scanning |
| PSD Length [°2Th.]: | 0.51 |
| Offset [°2Th.]: | 0.0000 |
| Divergence Slit Type: | Fixed |
| Divergence Slit Size [°]: | 0.1250 |
| Specimen Length [mm]: | 10.00 |
| Measurement Temperature [° C.]: | 23.00 |
| Anode Material: | Cu |
| K-Alpha1 [Å]: | 1.54060 |
| K-A2/K-A1 Ratio: | 0.50000 |
| Generator Settings: | 400 mA, 400 kV |

The 001 of Miller indices were used to determine full width at half of the peak maximum (FWHM). The FWHM values were observed from powder x-ray diffraction patterns in Panalytical data viewer software. The results are summarized in Table 1 below.

### Determination of Z-Average Particle Size

The Z-average particle size of the layered materials was determined by dynamic laser light scattering on an aqueous dispersion of the material containing 1.0% by weight of the layered material. The instrument was a Malvern Zetasizer Nano ZS.

The following measurement and device settings were used:

| Sample Refractive Index | 1.5 | |
|---|---|---|
| Sample Absorption | 0.01 | |
| Syringe Filter | Fisher 191-2045 25 mm SFCA 0.45 mm | |
| Measurement Cuvette | FB55923 disposable polystyrene cuvettes | |
| Cuvette Fill Depth | 10-15 | mm |
| Measurement Temperature | 25° | C. |
| Equilibration Time | 120 | seconds |

| | |
|---|---|
| Laser Attenuation | Automatic |
| Repeat Measurements | 3 |

The results are summarized in Table 1 below.

### Measurement of Barrier Properties

The powder of layered silicate material was dispersed in deionized water under stirring until complete dispersing. A solution of polyvinylalcohol (Mowiol(R) 20-98 Mw 125000 g/mol) was added slowly to the silicate dispersion with stirring for 1 h. The total non-volatile content was 3% by weight. The weight ratio of silicate:polyvinylalcohol was 10:90. The composite dispersion was coated on a poly ethylene terephthalate (PET) foil having a thickness of 36 μm. The dry layer thickness of the coating layer was 1 μm. The coating layer was dried at 80° C. for 6 h. The oxygen transmission rate OTR of the coated foils was measured using Mocon Ox-Tran (1/50) type at relative humidity of 75%. The water vapor transmission rate WVTR of the coated foils measured using Mocon Permatran W (1/50 G) type at relative humidity of 75%. The results are summarized in Table 1

### Determination of Osmotic Swelling and Delamination of Layered Material Via Small Angel X-Ray Spectroscopy (SAXS)

The layered materials of the examples were measured on a small-angle diffraction system of the type Double Ganesha AIR (SAXSLAB). The X-ray source was a rotating anode (Cu, MicroMax 007HF, Rigaku Corp.) which delivered a micro-focused beam. The spatially resolved detector PILATUS 300K (Dectris AG) was used. The measurement was performed in glass capillaries of 1 mm diameter (glass no. 50, Hilgenberg) at room temperature (23° C.) and 5% by weight of the layered material in water. The radially averaged data were normalized to the primary beam and the measuring time before the solvent was removed. The data analysis was performed according to M. Stöter, B. Biersack, S. Rosenfeldt, M. J. Leitl, H. Kalo, R. Schobert, H. Yersin, G. A. Ozin, S. Förster, J. Breu, Angew. Chem. Int. Ed. 2015, 54, 4963-4967. The results are summarized in Table 1.

TABLE 1

| | | | Layer | | |
|---|---|---|---|---|---|
| | | | distance | | |
| | | Z average | d001 | | |
| | | Particle | calculated | OTR | WVTR |
| | FWHM | size | from SAXS | [ml/m2 | [g/m2 |
| Sample name | [°] | [nm] | [nm] | day] | day] |
| Example 1 | 0.23 | 10000 | 433 | 0.26 | 0.60 |
| Example 2 | 0.28 | 8000 | 448 | 0.08 | 0.55 |
| Example 3 | 0.35 | 2000 | 448 | 0.09 | 0.18 |
| Example 4 | 0.23 | 10000 | 440 | 0.23 | 0.75 |
| Example 5* | 0.09 | 15000 | 416 | 0.05 | 0.33 |
| Example 6* | No peak | below | Not | 27.50 | 3.30 |
| | | 125000 | determined | | |
| Laponite ® B* | 1.50 | 355 | not | 20.00 | 2.30 |
| | | | determined | | |
| PET foil* | | | | 28.00 | 3.40 |

*Indicates comparative Examples
Laponite ® B is a synthetic layered fluorosilicate. It is insoluble in water but hydrates and swells to ive translucent, colorless colloidal dispersions. Laponite ® B is commercially available from BYK-Chemie GmbH.

From Table 1 it can be concluded that the examples according to the invention lead to a very good improvement in oxygen and water vapor barrier properties, when coated on a PET foil. The barrier properties are on the same level as those obtained with the comparative layered material of comparative Example 5. The layer distance values d001 indicate a complete delamination of the material in water. However, the layered materials of Examples 1 to 4 according to the invention were prepared via a process which is economically far more attractive than the process used to prepare the layered material of comparative Example 5. Comparative Example 6 was prepared analogously to Example 1. However, in comparative Example 6 the cooling rate was considerably faster as in Example 1. The material of comparative Example 6 provides poor barrier properties. This demonstrates that the cooling rate of the homogenous melt significantly determines the properties of the layered silicate. Laponite B is a commercially available layered material having a similar composition as Examples 1 to 5. This material has a small particle size. As a consequence, poor gas barrier properties were observed.

1. A material comprising a layered material having the composition Naₓ[Mg_{3-z}Li_{y}]Si₄O₁₀(T)₂, wherein
x is in the range of 0.4 to 0.8,
y is in the range of 0.0 to 0.8,
z is in the range of 0.2 to 0.8,
T independent of each occurrence represents F or OH, and
x+(3−z)+y≤4,
wherein the powder X-ray diffraction pattern of the layered material has a 001 peak in the range of 8.00 to 5.88° 2Theta, and wherein the 001 peak has a full width at half of the peak maximum of larger than 0.10°, and
wherein the layered material has a Z-average particle size of 500 nm or higher, determined by dynamic laser light scattering on an aqueous dispersion of the material containing at most 1.5% by weight of the material.

2. The material according to claim 1, wherein T in at least 50% of the occurrences represents F.

3. The material according to claim 1, wherein y is in the range of 0.4 to 0.8.

4. The material according to claim 1, wherein the Z-average particle size of the layered material is in the range of 500 nm to 25000 nm.

5. The material according to claim 1, wherein the material comprises 80 to 100% by weight of the layered material.

6. The material according to claim 1, wherein the material is obtained by a process comprising:
providing a mixture comprising Na compounds, Mg compounds, Li compounds, and Si compounds, wherein the Na compounds, the Mg compounds, the Li compounds, and the Si compounds are selected from carbonates, halides, and oxides, and wherein the molar ratio of Na:Mg:Li:Si is in the range of 0.4 to 0.8:2.2 to 2.8:0.0 to 0.8:4.0,
heating the mixture to a temperature above 1500° C. to form a homogeneous liquid, and subsequently
cooling the mixture to a temperature below 500° C. during period of at least 0.5 h.

7. A process for preparing a material comprising a layered material having the composition Naₓ[Mg_{3-z}Li_{y}]Si₄O₁₀(T)₂, wherein
x is in the range of 0.4 to 0.8,
y is in the range of 0.0 to 0.8,
z is in the range of 0.2 to 0.8,
T independent of each occurrence represents F or OH, and
x+(3−z)+y≤4,
wherein the powder X-ray diffraction pattern of the layered material has a 001 peak in the range of 8.00 to 5.88° 2Theta, and wherein the 001 peak has a full width at half of the peak maximum of larger than 0.10°, and
wherein the layered material has a Z-average particle size of 500 nm or higher, determined by dynamic laser light scattering on an aqueous dispersion of the material containing at most 1.5% by weight of the material,
the process comprising:
providing a mixture comprising Na compounds, Mg compounds, Li compounds, and Si compounds, wherein the Na compounds, the Mg compounds, the Li compounds, and the Si compounds are selected from carbonates, halides, and oxides, and wherein the molar ratio of Na:Mg:Li:Si is in the range of 0.4 to 0.8:2.2 to 2.8:0.0 to 0.8:4.0,
heating the mixture to a temperature above 1100° C. to form a homogeneous liquid, and subsequently
cooling the mixture to a temperature below 1000° C. during period of at least 2.0 h.

8. The process according to claim 7, wherein cooling the mixture is carried out during a period of at least 3.0 hours.

9. The process according to claim 7, wherein the process further comprises dispersing the material in an aqueous medium comprising water.

10. The process according to claim 9, further comprising heating the aqueous medium comprising the dispersed material to a temperature in the range of 50° C. to 400° C.

11. The process according to claim 7, further comprising grinding the material to a powder and heating the powder to a temperature in the range of 500° C. to 1100° C. for a period of at least 48 hours.

12. A composition comprising at least one binder and the material according to claim 1.

13. The composition according to claim 12, wherein the binder comprises at least one of an aqueous polymer solution or an aqueous polymer dispersion.

14. A method of improving the barrier properties of a coating layer, comprising including the material according to claim 1 in the coating layer.
